(19) United States
(12) Patent Application Publication
(10) Pub. No.: US 2022/0277371 A1
(43) Pub. Date: Sep. 1, 2022

(54) SYSTEM, APPARATUS, METHOD, AND COMPUTER PROGRAM PRODUCT FOR VERIFYING TRANSACTION COMPLIANCE IN AN ONLINE MARKETPLACE

(71) Applicants: David Chizi Obasiolu, Philadelphia, PA (US); Michael Chimenem Obasiolu, Port Harcourt (NG)

(72) Inventors: David Chizi Obasiolu, Philadelphia, PA (US); Michael Chimenem Obasiolu, Port Harcourt (NG)

(21) Appl. No.: 17/457,550

(22) Filed: Dec. 3, 2021

Related U.S. Application Data
(60) Provisional application No. 63/198,502, filed on Oct. 23, 2020.

(51) Int. Cl. G06Q 30/06; G06Q 30/00; G06F 21/60

(52) U.S. Cl. CPC G06Q 30/0609; G06Q 30/018; G06F 21/602

(57) ABSTRACT

A system, method, apparatus, and computer program product for verifying transaction compliance in an online marketplace. The system that combines verification data, including a user's name, age, and address to form a tokenized smart identity that automates the user's online compliance with state and federal laws when the user buys or sells products in an online cannabis marketplace. The process I have in place allows for an online marketplace to be smart and dynamic to ensure that both buyers and sellers comply with state and federal laws based on a created smart identity that is tokenized for privacy and security. The marketplace is configured with a product credential carried on a blockchain for a validation of the regulated product on the marketplace.

### CROSS-REFERENCE TO RELATED APPLICATION

This application claims the benefit of priority of U.S. provisional application No. 63/198,502 filed Oct. 23, 2020, the contents of which are herein incorporated by reference.

### BACKGROUND OF THE INVENTION

The present invention relates to transactions in an online marketplace, and more particularly to verification of transaction compliance in an online marketplace over a regulated product. The problem with online marketplaces today is that they are not dynamic enough to adapt to the variations in state and federal laws that may regulate the transaction of goods between a buyer and seller. In some instances, regulations may apply to the buyer, such as age limits, and the like, and requirements for the seller, such as whether they are licensed to transact a particular product.

Existing online marketplaces often lack a verification mechanism for ensuring that the buyer meets regulatory requirements in the jurisdiction in which they are located and sometimes, the regulatory requirements in the jurisdiction in which the seller is located.

Even in instances where a verification mechanism is in place, they are often not dynamic enough to accommodate changes, that may occur over time, in relevant regulatory frameworks.

Moreover, the verification data is often not protected for privacy and security.

As can be seen, there is a need for improved systems, methods, and apparatus, and computer program product for the verification of regulated transactions in an online marketplace that is tokenized for privacy and security.

### SUMMARY OF THE INVENTION

In one aspect of the present invention, a system for transaction of regulated products in an online marketplace is disclosed. The system includes a non-transitory memory and one or more hardware processors coupled to the non-transitory memory and configured to read instructions from the non-transitory memory to cause the system to perform operations. The operations include receiving a buyer input for establishing a tokenized smart identity of the buyer within the marketplace. The tokenized smart identity captures one or more buyer qualifications for purchasing a regulated product. The tokenized smart identity of the buyer is processed via a compliance engine configured to select one or more regulated products based on the one or more buyer qualifications. The one or more regulated products are listed via a buyer web browser. A listing of each of the one or more regulated products includes an indication of a product credential of the regulated product. The product credential of the regulated product is retained on a blockchain providing an immutable record of the product credential.

In some embodiments, the product credential includes a certificate of analysis containing results of a laboratory analysis of the regulated product. The certificate of analysis is preferably verified before incorporation with the product credential on the blockchain. The product credential is retrievable from the blockchain, via the buyer web browser.

In some embodiments, the one or more buyer qualifications is a geographic location of the buyer. The one or more buyer qualifications may also be an age of the buyer. The one or more buyer qualifications may also include a name of the buyer.

In other aspects of the invention, a system for transaction of regulated products in an online marketplace, is disclosed. The system includes a non-transitory memory and one or more hardware processors coupled to the non-transitory memory and configured to read instructions from the non-transitory memory to cause the system to perform operations, The operations include receiving a seller input for establishing a tokenized smart identity of the seller within the marketplace. The tokenized smart identity capturing one or more seller qualifications for offering a regulated product in the marketplace for regulated product. The tokenized smart identity of the seller is processed via a compliance engine configured to select one or more categories of regulated products the seller may sell in the marketplace, based on the one or more seller qualifications. A regulated product listing is received via a seller web browser, according to the one or more categories. A product credential of for the regulated product listing is registered on a blockchain providing an immutable record of the product credential.

In some embodiments, product credential includes a certificate of analysis containing results of a laboratory analysis of the regulated product. The certificate of analysis is verified before incorporation with the product credential on the blockchain. The product credential may be accessed from the blockchain, via the seller web browser.

In some embodiments, the one or more seller qualifications is a geographic extent for the regulated product listing. The one or more seller qualifications is one or more of a seller license or a seller registration. In some embodiments, the one or more buyer qualifications is a name of the seller.

These and other features, aspects and advantages of the present invention will become better understood with reference to the following drawings, description and claims.

### BRIEF DESCRIPTION OF THE DRAWINGS

FIG. 1 is a representative system flowchart for an online cannabis marketplace.

FIG. 2 is a representative implementation of a blockchain for use with the online cannabis marketplace.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, embodiments of the present invention provide a system, method, apparatus, and computer program product for implementing an online marketplace for a regulated product with a verification of an online transaction in a regulated product. User verification data is tokenized for privacy and security.

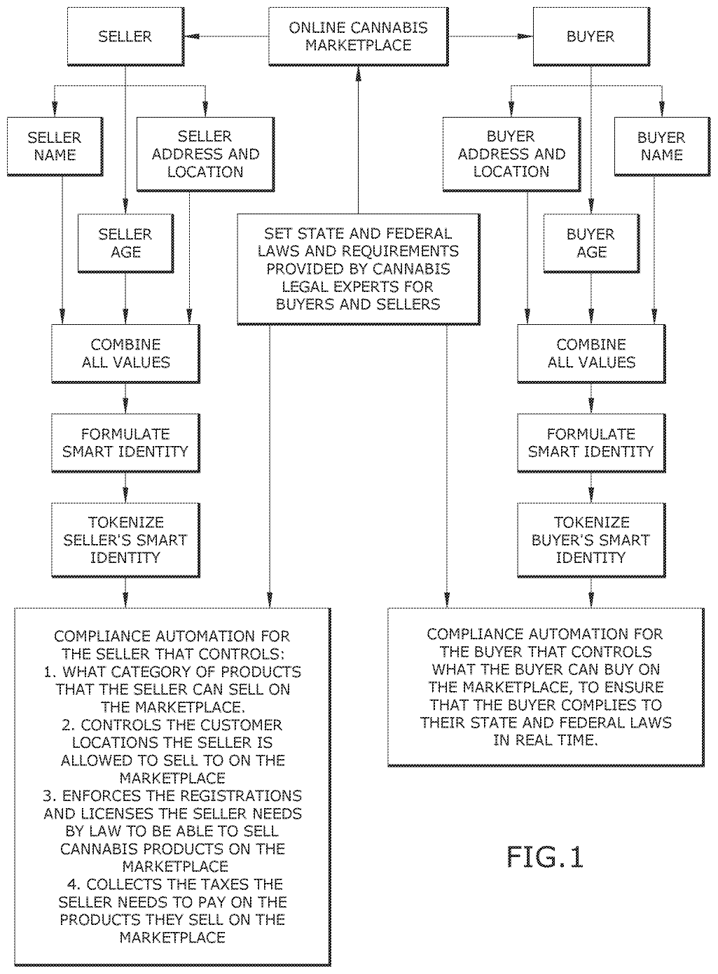

As seen in reference to FIG. 1, when a user (customer or seller) signs up on the online marketplace, the software system asks the user to provide their verification data, which may include their name, age, and address information to complete the signup process. Depending upon the nature of the regulated product, additional verification data may be solicited and input into the system.

If the user is a buyer, the system combines all the identity data elements provided by the user to formulate a tokenized smart identity. The tokenized smart identity is encrypted and hidden. The smart identity is automatically correlated to one or more transaction validation rules that are derived from a set of rules, laws, and regulations governing transactions in the regulated product. The transaction validation rules may be derived from legal experts and are tailored to fit the customers identity and controls what the customer can buy in the online marketplace to ensure that the customer complies to their state and federal laws, in real time.

If the user is a seller, the system uses the collected verification data to form the seller's smart identity. The seller's smart identity is tokenized for privacy and security. The tokenized smart identity for the seller is then correlated to one or more transaction validation rules. The transaction validation rules are a set requirements from legal experts that controls what category of controlled products the seller can sell on the online marketplace. The transaction validation rules also control the customer locations the seller can sell to on the online marketplace. The transaction validation rules also enforce one or more registrations the seller needs to be able to sell the regulated product on the marketplace. The transaction validation rules may also be configured to collect one or more taxes the seller may need to pay on the products they sell on the online marketplace for regulated products, for example an online cannabis marketplace.

Once each of the buyer and the seller have established their tokenized smart identity, an automated compliance engine ensures that each of the buyer and the seller remain in compliance with applicable rules, laws, and regulations when transacting the controlled or regulated product. For the buyer, the automated compliance engine verifies information from their tokenized smart identity and only enables browsing of marketplace for regulated products that the buyer is able to purchase.

For the seller, the automated compliance engine automatically controls a category of regulated products that the seller is able to list in the marketplace for regulated products. The automated compliance engine also controls the customer locations the seller is authorized to sell to within the marketplace. The automated compliance engine also enforces applicable registrations and licenses the seller needs to be able to sell the regulated products in the marketplace. In some embodiments, the automated compliance engine may be configured to collect taxes the seller needs to pay for transactions of the regulated products in the marketplace.

The claimed invention differs from what currently exists. As previously indicated, existing online marketplaces do not provide an environment that facilitates compliance for regulated products. In a non-limiting embodiment, the regulated product may be cannabis products. Hence, cannabis products are usually banned from online marketplaces. The present invention enables marketplaces to support cannabis products by automating the compliance of all users on the marketplace in real-time to ensure compliance with applicable state and federal laws. In a nonlimiting embodiment, the system doesn't focus on a local scene but emphasizes on automating cannabis compliance for users all over the world through one marketplace.

Embodiments of the present invention may include the following steps:

1. Collection of users' locations on the marketplace: this allows the system to aggregate all jurisdictional state and federal laws of the customer.

2. Collection of users' ages: This enables the system to collect the customer age to enforce compliance with age-requirements from state and federal laws.

3. Collection of the users' name: This enables the system to build and create an identifier that makes up majority of the user's smart identity.

All components make up the tokenized customer identity which is used for automating compliance on the marketplace. Combination of the location 1 of user, users' age 2, and users' name 3, enables the marketplace to form a smart identity that automates the compliance for both a customer and seller on the cannabis marketplace.

The online marketplace may be implemented with a computer, a server, and a computer program product to combine HTML, CSS, PHP, JavaScript and other web or mobile software tools to build and tokenize the smart identities for users in the marketplace and correlate the smart identities with set rules, laws, and regulations that enforce compliance for both buyers and sellers on the online marketplace in real time.

The system would be implemented in an online marketplace to control buyer and seller access in the online marketplace. The system may find great applicability to an online cannabis marketplace. The invention can produce a pass card or any form of access control device that is controlled by the logic on the software, which grants or revokes user access to expedite entry to the online marketplace. examples of access control devices are and not limited to pass cards, key fobs, access tokens, etc.

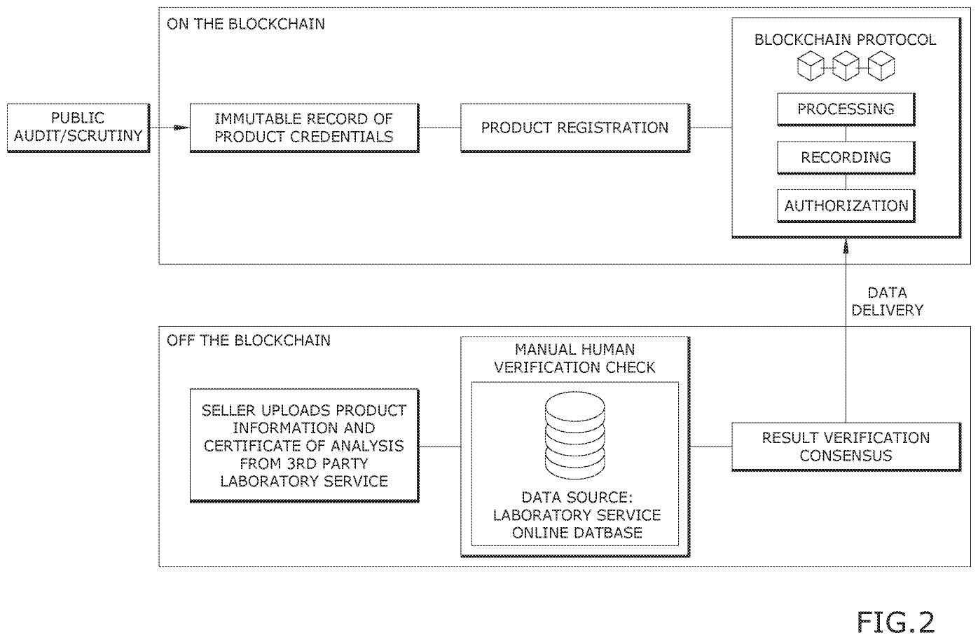

As seen in reference to FIG. 2, the marketplace for regulated products may also provide a record of product credentials for a registration of the regulated products transacted on the marketplace. The product credentials are retained on a blockchain.

In an off-blockchain process, the seller of a regulated product uploads a product certificate of analysis for the product, or a discrete quantity thereof, to a laboratory service data source. The product certificate of analysis for the product may be obtained from test results of a third-party laboratory service. A verification of the product certificate of analysis is performed in which a verification service verifies the uploaded certificate of analysis with the third-party laboratory. Once the product certificate of analysis has been verified, the product certificate of analysis is uploaded to the blockchain via a blockchain protocol.

The blockchain protocol performs each of an authorization, a recording, and a processing of the product certificate of analysis. During the authorization, the system confirms the validity of the product information report. After a secondary fact-checking of the certificate of analysis by operators of the marketplace to ensure the integrity of products carried in the marketplace. The processing is an intermediate stage between the authorization and recording. This is where the migration of the certificate of analysis to the registration on the blockchain occurs. During the recording, the certificate of analysis is registered on the blockchain ledger, the digital ledger token in practice. The digital ledger token provides the immutable record of information on the blockchain. Data is stored on network.

During a purchase, or prospective purchase of the regulated product, a listing of the regulated product from the seller may be provided with an indication of the product certificate of analysis associated with the regulated product. The indication may be a badge or a logo from the certifying source. The indication may also include specific information, such as the laboratory test results for the regulated product identified in the certificate of analysis. In some embodiments, the listing may provide the buyer a link to confirm the authenticity of the certificate of analysis on the blockchain. In this manner, the user may confirm the quality of the regulated product before making their purchasing decision.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for transaction of regulated products in an online marketplace, comprising:
a non-transitory memory; and
one or more hardware processors coupled to the non-transitory memory and configured to read instructions from the non-transitory memory to cause the system to perform operations comprising:
receiving a buyer input for establishing a tokenized smart identity of the buyer within the marketplace, the tokenized smart identity capturing one or more buyer qualifications for purchasing a regulated product;
processing the tokenized smart identity of the buyer via a compliance engine configured to select one or more regulated products based on the one or more buyer qualifications; and
listing, via a buyer web browser, the one or more regulated products, wherein a listing of each of the one or more regulated products includes an indication of a product credential of the regulated product, wherein the product credential of the regulated product is retained on a blockchain providing an immutable record of the product credential.

2. The system of claim 1, the product credential further comprising:
a certificate of analysis containing results of a laboratory analysis of the regulated product.

3. The system of claim 2, wherein the certificate of analysis is verified before incorporation with the product credential on the blockchain.

4. The system of claim 3, further comprising:
accessing the product credential from the blockchain, via the buyer web browser.

5. The system of claim 1, wherein the one or more buyer qualifications is a geographic location of the buyer.

6. The system of claim 1, wherein the one or more buyer qualifications is an age of the buyer.

7. The system of claim 1, wherein the one or more buyer qualifications is a name of the buyer.

8. A system for transaction of regulated products in an online marketplace, comprising:
a non-transitory memory; and
one or more hardware processors coupled to the non-transitory memory and configured to read instructions from the non-transitory memory to cause the system to perform operations comprising:
receiving a seller input for establishing a tokenized smart identity of the seller within the marketplace, the tokenized smart identity capturing one or more seller qualifications for offering a regulated product in the marketplace for regulated product;
processing the tokenized smart identity of the seller via a compliance engine configured to select one or more categories of regulated products the seller may sell in the marketplace, based on the one or more seller qualifications; and
receiving a regulated product listing, via a seller web browser, according to the one or more categories; and
registering a product credential of for the regulated product listing on a blockchain providing an immutable record of the product credential.

9. The system of claim 8, the product credential further comprising:
a certificate of analysis containing results of a laboratory analysis of the regulated product.

10. The system of claim 9, wherein the certificate of analysis is verified before incorporation with the product credential on the blockchain.

11. The system of claim 10, further comprising:
accessing the product credential from the blockchain, via the seller web browser.

12. The system of claim 8, wherein the one or more seller qualifications is a geographic extent for the regulated product listing.

13. The system of claim 8, wherein the one or more buyer qualifications is one or more of a seller license or a seller registration.

14. The system of claim 8, wherein the one or more seller qualifications is a name of the seller.
